(19) United States
(12) Patent Application Publication
(10) Pub. No.: US 2012/0124386 A1
(43) Pub. Date: May 17, 2012

(54) Method and System for Refreshing Content in a Storage Device

(76) Inventors: Jason T. Lin, Los Gatos, CA (US); Rotem Sela, Haifa (IL); Yonatan Halevi, Kfar Uria, IL (US); Avraham Shmuel, Herzliya (IL)

(21) Appl. No.: 12/947,034

(22) Filed: Nov. 16, 2010

(51) Int. Cl. G06F 12/14; G06F 21/00

(52) U.S. Cl. 713/182; 726/17

(57) ABSTRACT

A method and system for refreshing content in a storage device are disclosed. In one embodiment, a content replication system authenticates to each of a plurality of storage devices in parallel without creating a unique secure channel with each respective storage device. After authenticating to each of the plurality of storage devices, the content replication system is permitted to write content to, but not read content from, each of the plurality of storage devices. The content replication system then writes content to each of the plurality of storage devices in parallel.

### BACKGROUND

Content can be pre-loaded onto optical discs and other storage devices and sold to consumers. In many situations, storage devices with a given pre-loaded content title are overproduced. For relatively inexpensive write-once storage devices, such as optical discs, extraneous storage devices can be discarded. However, for relatively expensive storage devices, such as flash memory storage devices, it is desired to repurpose extraneous storage devices for other uses. For example, pre-loaded content and associated security features can be wiped from the storage device, so that the storage device can be sold as a standard, non-secure storage device. However, because a standard, non-secure storage device is typically sold to consumers at a lower price than a secure storage device with pre-loaded content, such repurposing can have a significant financial impact and create unpredictability in the supply chain. As another example of repurposing, a storage device with “stale” content can be loaded with “fresh” content (and updated security information) that may be more desired by consumers. However, a difficulty can be encountered if the storage device uses an authentication system to prevent unauthorized access to the storage device. With such secure storage devices, a content replication system would typically have to authenticate to each storage device that needs a content refresh using a storage-device-unique authentication method. Performing such one-to-one authentication with each storage device can be an expensive and time-consuming process, which can make refreshing content on a storage device an impractical business model, especially if performed on the large scale.

### SUMMARY

Embodiments of the present invention are defined by the claims, and nothing in this section should be taken as a limitation on those claims.

By way of introduction, the embodiments described below generally relate to a method and system for refreshing content in a storage device. In one embodiment, a content replication system authenticates to each of a plurality of storage devices in parallel without creating a unique secure channel with each respective storage device. After authenticating to each of the plurality of storage devices, the content replication system is permitted to write content to, but not read content from, each of the plurality of storage devices. The content replication system then writes content to each of the plurality of storage devices in parallel.

Other embodiments are provided, and each of the embodiments can be used alone or together in combination. Various embodiments will now be described with reference to the attached drawings.

### BRIEF DESCRIPTION OF THE DRAWINGS

FIG. 1 is a diagram of a content replication system of an embodiment.

FIG. 2 is a diagram of a storage device of an embodiment

FIG. 3 is a diagram of an authentication process of an embodiment in which a unique secure channel is created with a storage device.

FIG. 4 is a diagram of an authentication process of an embodiment in which a non-unique secure channel is created with a storage device.

FIG. 5 is an illustration of a double domain encryption technique of an embodiment.

FIG. 6 is a diagram illustrating a system of an embodiment for refreshing content in a storage device.

FIG. 7 is a flow chart of a method of an embodiment for refreshing content in a storage device.

FIG. 8 is a diagram illustrating a process of an embodiment for refreshing content in a storage device.

### DETAILED DESCRIPTION OF THE PRESENTLY PREFERRED EMBODIMENTS

Introduction

As discussed above, content pre-loaded into a storage device can become undesirable over time, and it may be preferred to store new content in the storage device to make it more likely to be purchased by a consumer. A content replication system may need to authenticate to the storage device and create a unique secure channel with the storage device prior to writing new content. However, performing one-to-one authentication and secure channel creation with a plurality of storage devices can be an expensive and time-consuming process that can make refreshing content on a storage device an impractical business model, especially if performed on the large scale.

The embodiments described below can be used to overcome this problem (the embodiments can also be used in other applications). In some of these embodiments, the content replication system authenticates to a plurality of storage devices in parallel without creating a unique secure channel with each storage device. This eliminates the bottleneck discussed above and, therefore, can make refreshing content on a storage device a practical business model. Although a unique secure channel is not created with each storage device, a number of security measures can be used to protect content sent to a storage device. For example, instead of creating a unique secure channel with each storage device, the content replication system can create non-unique secure channels with the storage devices by using a common secure channel key. Creating non-unique secure channels in this manner is less time intensive than creating unique secure channels and still provides a relatively strong level of protection of the content as it is being sent to the storage devices. As another example, instead of or as an alternative to creating non-unique secure channels, the content replication system can send content to the storage devices using a common transport encryption key. Each storage device could decrypt the encrypted content with the common transport encryption key upon receipt. In some embodiments, a storage device can be further configured to re-encrypt the content with a key unique to the storage device and store the re-encrypted content in the storage device. This process is referred to herein as “double-domain encryption.”

Additionally, in some embodiments, the content replication system can be permitted to write content to, but not read content from, the storage devices. This can be implemented, for example, by having the content replication system authenticate to a write-only account in the storage device. Alternatively, content refreshing can be performed using an application programming interface that allows a write command, but not a read command. Further, the content replication system can verify the integrity of the content written to the storage devices.

As can be understood from this introduction, the embodiments presented below can provide a cost effective and efficient way to write content to a storage device without compromising security. Before providing a detailed discussion of various aspects of these embodiments, an overview of an exemplary content replication system and storage device is provided.

Overview of an Exemplary Content Replication System and Storage Device

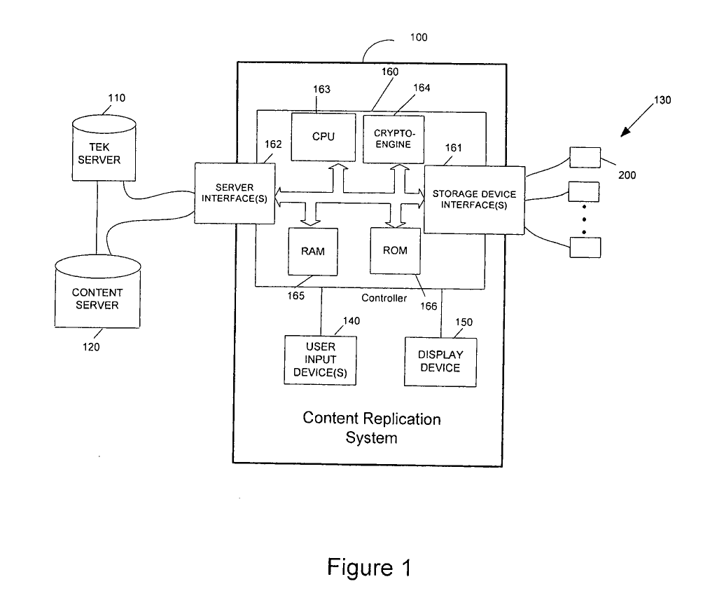

Turning now to the drawings, FIG. 1 is a representation of a content replication system 100 of an embodiment. In general, the content replication system 100 is used to write (or replicate) content onto a plurality of storage devices 130. As used herein, “content” can take any suitable form, such as, but not limited to, digital video (with or without accompanying audio) (e.g., a movie, an episode of a TV show, a news program, etc.), audio (e.g., a song, a podcast, one or a series of sounds, an audio book, etc.), still or moving images (e.g., a photograph, a computer-generated display, etc.), text (with or without graphics) (e.g., an article, a text file, etc.), a video game, and a hybrid multi-media presentation of two or more of these forms. A “storage device” can also take any suitable form. In one embodiment, a storage device takes the form of a solid-state (e.g., flash) storage device and can be one-time programmable, few-time programmable, or many-time programmable. The storage device can take the form of a handheld, removable memory card, an embedded memory card, a universal serial bus (USB) device, or a removable or non-removable hard drive, such as a solid-state drive, for example.

As shown in FIG. 1, the content replication system 100 of this embodiment comprises user input device(s) 140 (e.g., a keyboard, a mouse, etc.) and a display device 150, through which a user can input and review data to initiate a content replication session. Although shown as separate components, the user input device(s) 140 and the display device 150 can be integrated, such as when the display device 150 takes the form of a touch-screen display. The user input device(s) 140 and the display device 150 are in communication with a controller 160. In one embodiment, the content replication system 100 takes the form of a computer with a WinXP card reader using Win2K USB drivers and a general-purpose interface bus (GPIB) controlling a memory card handler, such as a TSE FH1280 handler, a Mirae MR5500 handler, a Mirae MR7XXX handler, and a TSE Manual RMA handler.

In this embodiment, the controller 160 comprises a central processing unit (“CPU”) 163, a crypto-engine 164 operative to provide encryption and/or decryption operations, read access memory (RAM) 165, and read only memory (ROM) 166. The controller 160 also comprises storage device interface(s) 161, which contain the necessary hardware and/or software for placing the controller 160 in communication with the plurality of storage devices 130. (As used herein, the phrase “in communication with” could mean directly in communication with or indirectly in communication with through one or more components, which may or may not be shown or described herein.) For example, the storage device interface(s) 161 can contain the physical and electrical connectors to simultaneously host the plurality of storage devices 130, or it can contain the physical and electrical connectors to host a separate card reader, which can simultaneously host the plurality of storage devices 130. The controller 160 further comprises server interface(s) 162, which contain the necessary hardware (e.g., one or more network jacks) and/or software for placing the controller 160 in communication with one or more servers. For example, as shown in FIG. 1, the content replication system 100 can be in communication with a transport encryption key (“TEK”) server 110 and a content server 120. The use of a transport encryption key will be described in more detail below, although it should be noted now that the use of a transport encryption key is not necessary in all embodiments.

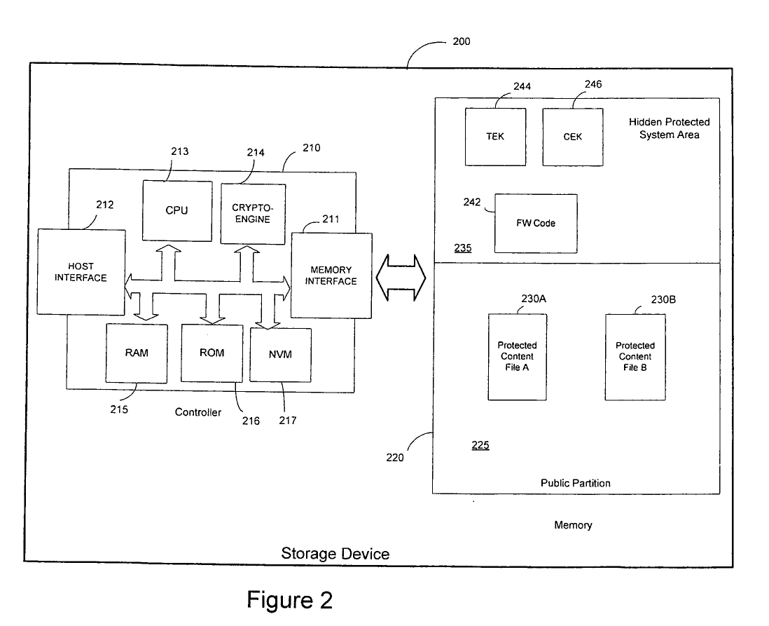

Returning to the drawings, FIG. 2 is an illustration of an exemplary storage device 200 of an embodiment (other storage device implementations can be used with these embodiments). As shown in FIG. 2, the storage device 200 comprises a controller 210 and a memory 220. The controller 210 comprises a memory interface 211 for interfacing with the memory 220 and a host interface 212 for interfacing with the host 250. (The host 250 can be the content replication system 100 of FIG. 1 or can be another device, such as, but not limited to, a dedicated content player, a mobile phone, a personal computer, a game device, a personal digital assistant (PDA), a kiosk, a set-top box, and a TV system.) The controller 210 also comprises a central processing unit (CPU) 213, a crypto-engine 214 operative to provide encryption and/or decryption operations (the crypto-engine 214 can be implemented in hardware or software), read access memory (RAM) 215, read only memory (ROM) 216 which stores firmware for the basic operations of the storage device 200, and a non-volatile memory (NVM) 217 which stores a device-specific key used for encryption/decryption operations. In this embodiment, the storage device 200 takes the form of a handheld, removable memory card (or hard drive) that can be interchangeably used in a wide variety of host devices. However, other form factors can be used, such those used for a USB device or a solid-state drive.

The memory 220 can take any suitable form. In one embodiment, the memory 220 takes the form of a solid-state (e.g., flash) memory and can be one-time programmable, few-time programmable, or many-time programmable. However, other forms of memory can be used. In this embodiment, the memory 220 comprises a public partition 225 that is managed by a file system on a host and a hidden protected system area 235 that is internally managed by the controller 310. The hidden protected system area 235 stores firmware (FW) code 242 which is used by the controller 210 to control operation of the storage device 200, as well as a transport encryption key (TEK) 244 and a content encryption key (CEK) 246, which will be described below. (In an alternate embodiment, one or both of the TEK 244 and CEK 246 can be stored in the NVM 217.) Also, in some embodiments, the memory 220 can have a hidden, but unprotected area.

The public partition 225 and the hidden protected system area 235 can be part of the same memory unit or can be different memory units. The hidden protected system area 235 is “hidden” because it is internally managed by the controller 210 (and not by the host's controller) and is “protected” because objects stored in that area 235 are encrypted with the unique key stored in the non-volatile memory 217 of the controller 210. Accordingly, to access objects stored in that area 235, the controller 210 would use the crypto-engine 214 and the key stored in the non-volatile memory 217 to decrypt the encrypted objects. Preferably, the storage device 200 takes the form of a secure product from the family of products built on the TrustedFlash™ platform by SanDisk Corporation.

The public partition 225 of the memory stores protected content files 230A, 230B. The content 230A, 230B can be preloaded, side-loaded, or downloaded into the memory 220. While the public partition 225 of the memory 220 is managed by a file system on the host, objects stored in the public partition 225 (such as the content files 230A, 230B) may also be protected by the storage device 200. In this embodiment, both stored content files 230A, 230B are protected by respective content encryption keys 240 stored in the hidden protected system area 235, and those keys 240 are themselves protected by the memory-device unique key stored in the non-volatile memory 217 of the controller 210. Accordingly, to unprotect one of the protected content files (say, content file 230A), the crypto-engine 214 would use the memory-device unique key stored in the non-volatile memory 217 of the controller 210 to decrypt the appropriate content encryption key 240 and then use the decrypted content encryption key 240 to decrypt the protected content 230A.

The controller 210 can be implemented in any suitable manner. For example, the controller 210 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. Examples of controllers include, but are not limited to, the following microcontrollers: ARC 625D, Atmel AT91SAM, Microchip PIC 18F26K20, and Silicon Labs C8051F320. Examples of various components that can be used in a controller are described in the embodiments discussed herein and are shown in the associated drawings. The controller 210 can also be implemented as part of the memory 320 control logic.

The storage device 200 and a host (e.g., the content replication system 100) can communicate with each other via a host interface 212. In one embodiment, for operations that involve the secure transfer of data, the crypto-engine 214 in the storage device 200 and the crypto-engine 164 in the content replication system 100 can be used in an authentication process. The following section discusses exemplary authentication processes in more detail.

Discussion of Exemplary Authentication Processes

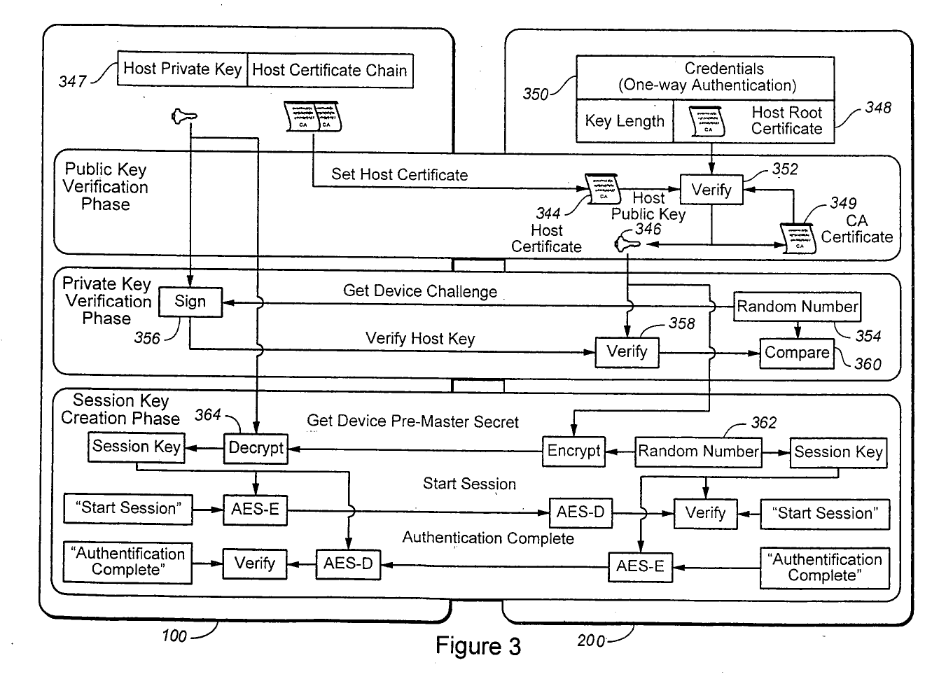

Any suitable authentication process can be used to authenticate the content replication system 100 to the plurality of storage devices 130 (e.g., symmetric key authentication, asymmetric authentication, authentication using a password, etc.) For example, FIG. 3 is a diagram depicting a one-way asymmetric PKI-RSA authentication process (a two-way mutual authentication process analogous to the one-way authentication process can also be used). As shown in FIG. 3, this authentication process contains three phases: a public key verification phase, a private key verification phase, and a session key creation phase. During the public key verification phase, the content replication system 100 (e.g., the host) sends a host certificate chain to the storage device 200. The storage device 200 verifies genuineness of the host certificate 344 and of the host public key 346 using the root certificate authority public key located in the host root certificate 348 stored in the storage device 200 (block 352). Where an intermediate certificate authority between the root certificate authority and the content replication system 100 is involved, the intermediate certificate 349 is used as well for the verification in block 352. Assuming that the verification process is successful, the authentication process proceeds to the private key verification phase.

In the private key verification phase, the storage device 200 generates a random number 354 and sends it as a challenge to the content replication system 100. The content replication system 100 signs the random number 354 using its private key (block 356) and sends the signed random number as the response to the challenge. The storage device 100 decrypts the response using the host public key 346 (block 358) and compares the decrypted response with the random number 354 (block 360). If the decrypted response matches the random number 354, the challenge response is successful, and the authentication process proceeds to the session key creation phase.

In the session key creating phase, the storage device 200 encrypts a random number 362 using the host public key 346. This random number 362 is then the session key. The content replication system 100 can obtain the session key by using its private key to decrypt the encrypted number 362 from the storage device 200 (block 364). With this session key, a unique secure channel between the content replication system 100 and the storage device 200 is created.

The above paragraphs described a process for authenticated to and creating a secure channel with an individual storage device. When refreshing content on a plurality of storage devices, the process described above would need to be repeated for each storage device, resulting in a plurality of secure channels—one for each storage device. Because each individual storage device would generate its own random number (session key), each storage device would have a unique secure channel. Therefore, there would be a unique secure channel with each of the various storage devices. The process of creating a secure channel can be time consuming, especially on a larger scale, which can make it impractical to refresh content on a plurality of storage devices.

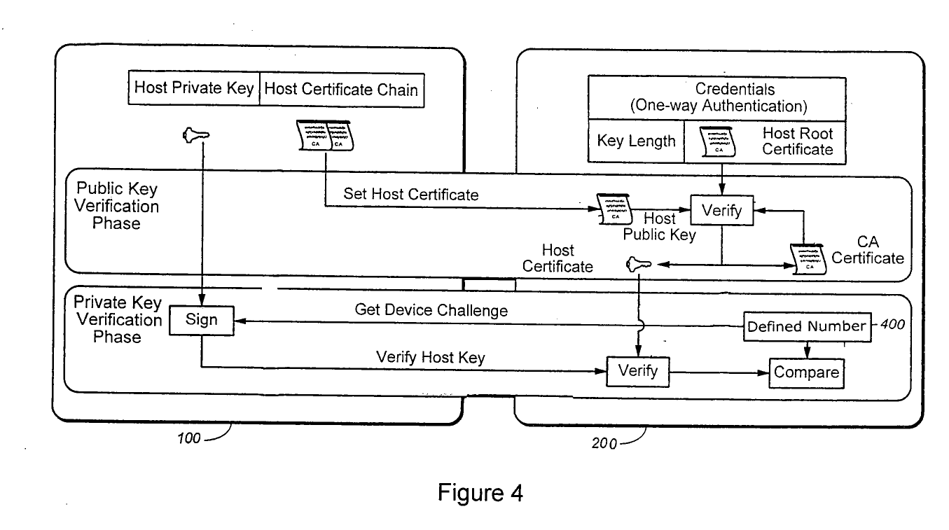

To overcome this problem, the content replication system 100 of this embodiment can authenticate to the plurality of storage devices 130 in parallel without using a storage-device-unique authentication method and without creating a unique secure channel with each respective storage device. As shown in FIG. 4, the authentication process in this embodiment includes the public key verification phase and the private key verification phase, similar to the authentication process shown in FIG. 3. However, unlike that other authentication process, this authentication process does not include a session key creating phase, and a unique secure channel is not created. Eliminating this phase avoids the time-consuming process that can make refreshing content on a plurality of storage devices impractical.

Although unique secure channels are not used in this embodiment, various mechanisms can be used to protect the content being transferred from the content replication system 100 to the storage devices. For example, instead of using a random number in the private key verification phase, a defined number 400 (see FIG. 4) can be used, and the same defined number can be used in each of the storage devices. Because the same defined number is stored in each of the storage devices, this defined number can serve as a common secure channel key. (The common secure channel key can be pre-stored in each of the plurality of storage devices 130 prior to the content replication system 100 authenticating to the storage devices, or the common secure channel key can be sent (either in a one-to-one or one-to-many fashion) to each of the plurality of storage devices (preferably, in an encrypted form) by the content replication system 100 after authentication.) The content replication system 100 can use the common secure channel key to create non-unique secure channels with the plurality of storage devices (the channels are non-unique because the same secure channel key is used to create each of the secure channels). Because the secure channel key is predefined, the various time-consuming challenge-and-response steps of a typical session key creation phase are avoided. This provides a level of protection of the content while avoiding the time-intensive acts that can make content refreshing prohibitive.

While the above example shows that non-unique secure channels can be used instead of secure channels, it should be noted that the use of a secure channel (unique or non-unique) is not required with these embodiments. For example, in another content protection mechanism, which can be used instead of or in conjunction with establishing non-unique secure channels, the content sent from the content replication system 100 can be encrypted with a common transport encryption key (TEK). The common TEK would be stored in each of the storage devices authorized to receive the content, either because the common TEK was pre-stored in the storage devices or because the common TEK was sent to the storage devices (either serially or in parallel using a broadcast write) for storage. After a storage device decrypts the content with the common TEK, it can re-encrypt the decrypted content with a key unique to each respective storage device (a “content encryption key” or “CEK”). (A CEK can be generated by a storage device or sent to the storage device by the content replication system 100.) In this way, each respective storage device would store content that has been re-encrypted with a key unique to that storage device. Alternatively, a common CEK can be used for many storage devices, with the common CEK imported or preloaded into the storage devices.

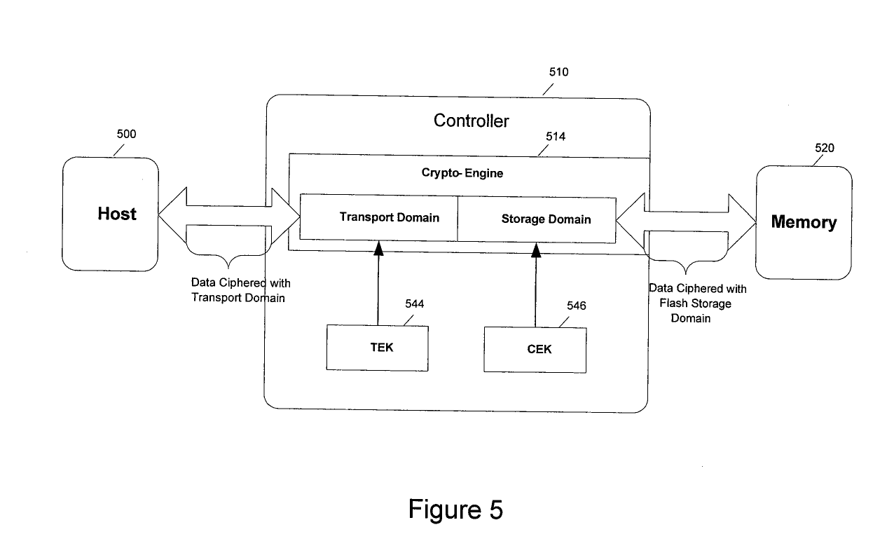

This process by which data is ciphered with one key, deciphered, and then enciphered with another key is referred to herein as “double domain encryption.” FIG. 5 illustrates the concept of double domain encryption in more detail. First, content (data) encrypted with a TEK is received from a host 500 (e.g., a content replication system). This data is ciphered with the transport domain in that the content is encrypted with the TEK to protect the content during transmission from the host 500 to the storage device. When the content is received at the storage device, the crypto-engine 514 in the controller 510 of the storage device decrypts the content with the TEK 544 stored in the storage device. This converts the content from the transport domain to clear content. (The transport domain uses the TEK 544 to cipher data coming into or going out of the storage device.) The crypto-engine 514 then takes the clear content and re-encrypts it with a key unique to the storage device, here the CEK 546. This decryption and re-encryption process can take place on-the-fly as the content is being received by the storage device 500. This places the content in the storage domain. (The storage domain uses the CEK 546 to cipher data written into or read out of the memory 520.) The storage device 500 then stores the data ciphered in the flash storage domain in the memory 520.

As noted above, TEK-encrypted content can be sent from the content replication system 100 to the plurality of memory devices 130 without establishing a unique or non-unique secure channel (although such a channel can be used). Because double domain encryption secures specific objects, the entire communication line between the content replication system 100 and the plurality of memory devices 130 does not need to be made secure. Accordingly, double domain encryption can be used to avoid the time needed to establish a secure channel and encrypt every piece of information going back and forth between the content replication system 100 and the plurality of memory devices 130.

Exemplary Embodiments Relating to Writing Content to a Storage Device

The above paragraphs described how a content replication system can authenticate to a plurality of storage devices in parallel without creating a unique secure channel with each respective storage device, as well as how content sent from a content replication system to a plurality of storage devices can be protected (e.g., using non-unique secure channels and/or double domain encryption). After the authentication process, the content replication system 100 can write content to the plurality of storage devices 130 in parallel. In this way, content is sent to the plurality of storage devices 130 in a broadcast fashion, which is a more time-efficient way of loading content into the plurality of storage devices 130, especially on a large scale. (In addition to writing content, the content replication system 100 can write updated security information, such as, but not limited to, keys, certificates, and certificate revocation lists.)

In embodiments where content is being written to a storage device to refresh stale content, there may be other content stored on the storage device. Even though this other content may be “stale,” it may be preferred to protect content stored on a storage device from being read by the content replication system 100. To provide such protection, after authenticating to a storage device 200, the content replication system 100 may be permitted to write content to, but not read content from, the storage device 200. Various mechanisms can be used to provide such protection. For example, a storage device 200 may have one or more accounts, and an entity (such as the content replication system 100) can authenticate to the storage device by authenticating to a specific account. In this way, the account in each storage device can specify that, upon authentication, an authenticated entity has permission to write content to, but not read content from, the storage device. When a storage device takes the form of a secure product from the family of products built on the TrustedFlash™ platform by SanDisk Corporation, the account can be an access control record (ACR), which is an account with its own authentication credential and access rights to the storage device. However, other types of accounts can be used.

It should be noted that write-only permission can be enforced without the use of accounts. For example, a storage device can have an application programming interface (“API”) that will allow a write command, but not a read command, to be successfully performed. For example, a content replication system can authenticate to each storage device using a Media Key Block method and establish a single common key with all storage devices to encrypt the data exchange. The content replication system can issue a content reloading write-only command to write new content into the storage devices, wherein the content written via this write only command can be encrypted by the common secure channel key. The storage devices can decrypt the content with the pre-established common key before storing the content in the storage device. If the application programming interface of the storage device receives a read command, the storage device can ignore the command or return erroneous or encrypted data.

In another embodiment, the content replication system 100 is able to verify the integrity of the content written to each of the plurality of storage devices. For example, as each storage device receives content from the content replication system 100, the storage device's crypto-engine can create a digital signature (e.g., using a Secure Hash Algorithm (SHA)) or a checksum of a specified length of content that the engine processed. This avoids the need for the content replication system 100 to read the actual content to verify successful programming, thereby avoiding the need to provide the content replication system 100 with read access to the storage device. The content replication system 100 can read the generated digital signature or checksum from a storage device and compare it to a reference digital signature or checksum associated with the content. While this content verification process is performed on a one-to-one basis with each storage device, this process is relatively fast and should not appreciably add delay to the content refreshing process.

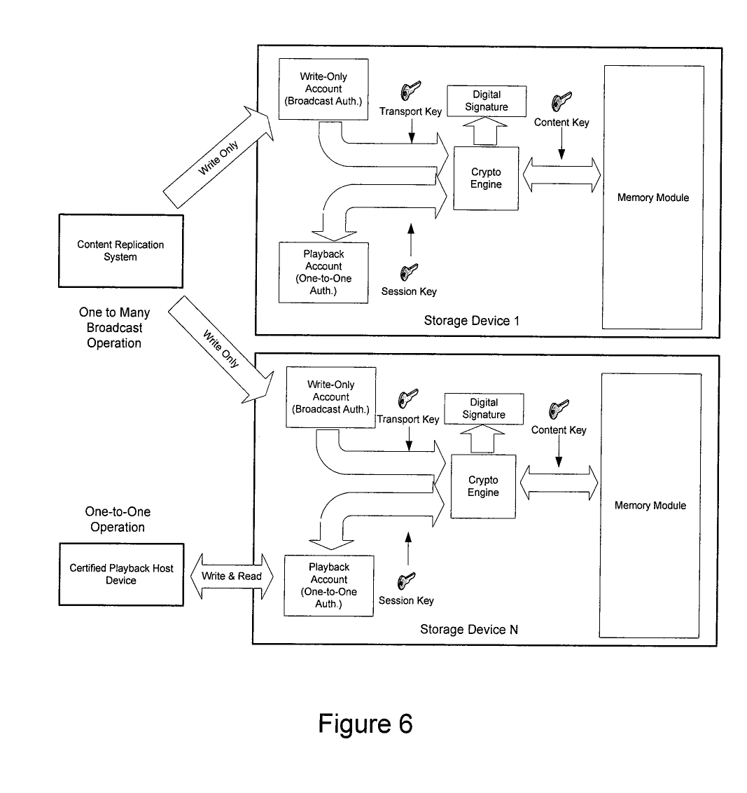

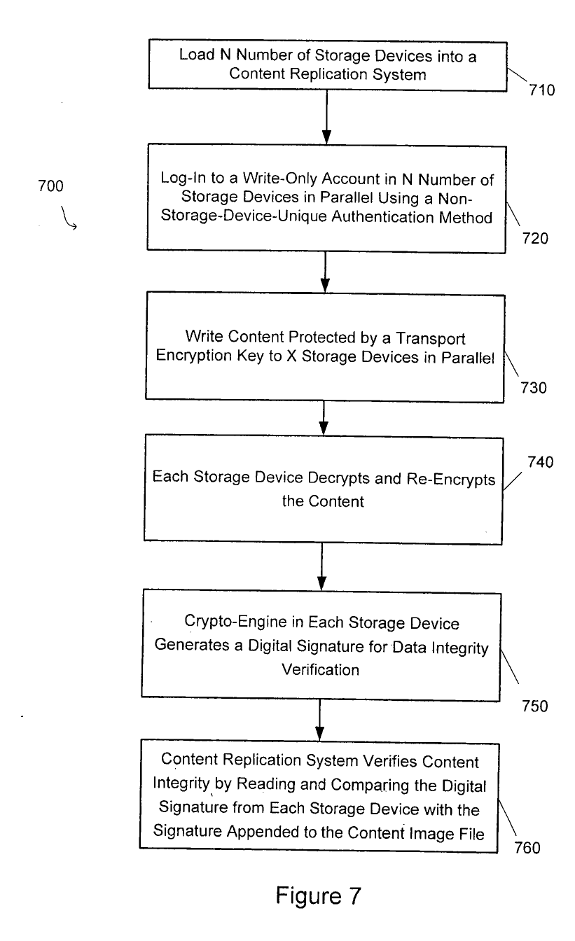

Returning to the drawings, FIGS. 6 and 7 shows a system diagram and flow chart 700, respectively, that illustrates an embodiment that uses a write-only account, double-domain encryption, and content verification features to simultaneously reload content into multiple secure storage devices in parallel. It should be noted that this is merely an example, and other embodiments can use a subset of these features or different features altogether. As shown in FIGS. 6 and 7, N storage devices are loaded into a content replication system (act 710). Next, the content replication system logs-in to a write-only account of each of the N number of storage devices in parallel (i.e., in a one-to-many broadcast fashion) using a non-storage-device-unique authentication method (act 720). As discussed above, using a non-storage-device-unique authentication method is faster than using a storage-device-unique authentication method and allows a “one to many” broadcast operation. As also discussed above, any suitable authentication method can be used, including, for example, those that use a non-unique login credential in the form of a password, symmetric key, asymmetric key, or obfuscation function.

After the content replication system authenticates to all of the N storage devices, the content replication system writes content protected by a transport encryption key (TEK) to the N storage devices in parallel (i.e., a one-to-many broadcast fashion) (act 730), and each of the N storage devices decrypts the content and then re-encrypts the content with a content encryption key (CEK) stored in the storage device (act 740). As discussed above, this “double-domain encryption” process allows content to be securely transferred from the content replication system to the N storage devices without establishing a unique secure channel with each storage device. However, as also discussed above, a non-unique secure channel can be established using a common defined number in each of the N storage devices.

Next, the crypto-engine in each of the N storage devices generates a digital signature for data integrity verification (act 750). In this way, instead of the content replication system reading back the content it wrote to the storage device, the content replication system can read the digital signature from each storage device and compare it to a reference signature, such as one appended to the content image file (act 760). If the write process is successful, prior content on the storage device can be left on the storage device or erased/written over.

FIG. 6 also diagrammatically illustrates the one-to-one operation used by a host device to read the content from the storage device. Instead of logging-in to a write-only account in a broadcast authentication manner, as done above, the host device would log-in to a playback account using a one-to-one storage-device-unique authentication method. This would generate a unique session key to establish a unique secure channel. In response to receiving a read command from the host device, the storage device would read data encrypted with a content encryption key (CEK) out of its memory and decrypt the encrypted with its crypto-engine. This clear data would then be encrypted by the session key and sent via the unique secure channel to the host device for playback.

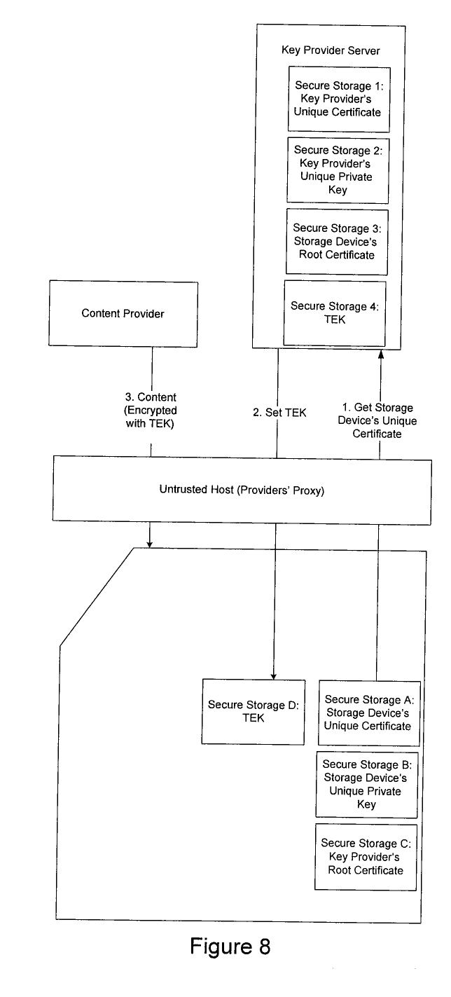

It should be noted that many alternatives can be used with these embodiments. For example, additional layers of security can be used to ensure that only authorized storage devices get the transport encryption key (TEK) needed to decrypt content. In general, content can be signed by a content owner's asymmetric private key, where the matching public key would be signed in a certificate issued by a third trusted party. During replication of content, the content would come with a certificate of the content owner and a signature of the content, so that the certificate and content could be checked for authenticity. This would help ensure that only authorized storage devices are able to decrypt the content, as such decryption would be independent of the security of the keys provided the content replication system. This alternative will be described in more detail in conjunction with FIG. 8.

FIG. 8 is a diagram illustrating how an un-trusted host can be used to initiate a connection with a key provider server to download a transport encryption key (TEK) for specific content. As shown in FIG. 8, the un-trusted host (e.g., a content replication system) gets the storage device's unique certificate (from secure storage A in the storage device) and passes it to the Key Provider Server. The Key Provider Server uses the storage device's root certificate (stored in the secure storage 3 in the Key Provider Server) to attempt to validate the storage device's certificate and validate that it is signed by a trusted entity. If the attempt fails, the Key Provider Server sends a command to the host to abort the process. If the attempt succeeds, the Key Provider Server encrypts the TEK (which is stored in secure storage 4 in the Key Provider Server) with the public key extracted from the storage device's unique certificate and signs the TEK using the Key Provider's private key (which is stored in secure storage 2 in the Key Provider Server).

The Key Provider Server then passes the signed and encrypted TEK along with the Key Provider's unique certificate (from secure storage 1 in the Key Provider Server) to the host, and the host stores the signed and encrypted TEK in secure storage D in the storage device. Before writing the TEK into secure storage D, the storage device preferably uses the Key Provider's root certificate (stored in the secure storage C in the storage device) to attempt to validate the Key Provider's certificate and validate that it is signed by a trusted entity. If the attempt fails, the storage device sends a command to the host to abort the process. If the attempt succeeds, the storage device uses its private key (stored in secure storage B in the storage device) to decrypt the TEK and then stores the TEK in secure storage D in the storage device. With the TEK provisioned in the storage device, content can be sent to the storage device from a content provider using the process discussed above.

### CONCLUSION

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A method for writing content to a plurality of storage devices, the method comprising:
performing in a content replication system in communication with a plurality of storage devices:
authenticating the content replication system to the plurality of storage devices in parallel, the content replication system being authenticated to each of the plurality of storage device without it creating a unique secure channel with each respective storage device, wherein after authenticating to each of the plurality of storage devices, the content replication system is permitted to write content to, but not read content from, each of the plurality of storage devices; and
writing content to each of the plurality of storage devices in parallel.

2. The method of claim 1 further comprising creating a non-unique secure channel with each of the plurality of storage devices by using a secure channel key that is common to all the plurality of storage devices.

3. The method of claim 2, wherein the common secure channel key is pre-stored in each of the plurality of storage devices prior to the content replication system authenticating to the plurality of storage devices.

4. The method of claim 2, wherein the common secure channel key is sent to each of the plurality of storage devices by the content replication system after authentication.

5. The method of claim 1, wherein the content sent to each of the plurality of storage devices is encrypted with a common transport encryption key.

6. The method of Clam 5, wherein each of the plurality of storage devices is configured to decrypt the encrypted content with the common transport encryption key, re-encrypt the content with a key unique to each respective storage device, and store the re-encrypted content in the storage device.

7. The method of Clam 5, wherein each of the common transport encryption key is provisioned to the plurality of storage devices by a key provider server after the plurality of storage devices are authenticated to the key provider server.

8. The method of claim 1, wherein the content replication system authenticates to the plurality of storage devices by authenticating to an account in each of the plurality of storage devices, and wherein each such account in each respective storage device specifies that, upon authentication, an authenticated entity has permission to write content to, but not read content from, the storage device.

9. The method of claim 1, wherein each of the plurality of storage devices has a respective application programming interface that will allow a write command, but not a read command, to be successfully performed.

10. The method of claim 1 further comprising verifying integrity of the content written to each of the plurality of storage devices.

11. The method of claim 10, wherein the integrity of the content written to each storage device is verified by:
reading a digital signature or checksum from a storage device, wherein the digital signature or checksum is generated by the storage device based on the content received by the storage device; and
comparing the read digital signature or checksum with a stored reference digital signature or checksum.

12. A content replication system comprising:
an interface configured to communicate with a plurality of storage devices;
a controller in communication with the interface and configured to:
authenticate to each of the plurality of storage devices in parallel without creating a unique secure channel with each respective storage device, wherein after authenticating to each of the plurality of storage devices, the content replication system is permitted to write content to, but not read content from, each of the plurality of storage devices; and
write content to each of the plurality of storage devices in parallel.

13. The content replication system of claim 12, wherein the controller is further configured to create a non-unique secure channel with each of the plurality of storage devices by using a secure channel key that is common to each of the plurality of storage devices.

14. The content replication system of claim 13, wherein the common secure channel key is pre-stored in each of the plurality of storage devices prior to the content replication system authenticating to the plurality of storage devices.

15. The content replication system of claim 13, wherein the common secure channel key is sent to each of the plurality of storage devices by the content replication system after authentication.

16. The content replication system of claim 12, wherein the content sent to each of the plurality of storage devices is encrypted with a common transport encryption key.

17. The content replication system of Clam 16, wherein each of the plurality of storage devices is configured to decrypt the encrypted content with the common transport encryption key, re-encrypt the content with a key unique to each respective storage device, and store the re-encrypted content in the storage device.

18. The content replication system of Clam 16, wherein each of the common transport encryption key is provisioned to the plurality of storage devices by a key provider server after the plurality of storage devices are authenticated to the key provider server.

19. The content replication system of claim 12, wherein the content replication system authenticates to the plurality of storage devices by authenticating to an account in each of the plurality of storage devices, and wherein each such account in each respective storage device specifies that, upon authentication, an authenticated entity has permission to write content to, but not read content from, the storage device.

20. The content replication system of claim 12, wherein each of the plurality of storage devices has a respective application programming interface that will allow a write command, but not a read command, to be successfully performed.

21. The content replication system of claim 12, wherein the controller is further configured to verify integrity of the content written to each of the plurality of storage devices.

22. The content replication system of claim 21, wherein the controller is further configured to verify the integrity of the content written to each storage device by:
reading a digital signature or checksum from a storage device, wherein the digital signature or checksum is generated by the storage device based on the content received by the storage device; and
comparing the read digital signature or checksum with a stored reference digital signature or checksum.
